(19) United States
(12) Patent Application Publication
(10) Pub. No.: US 2026/0156246 A1
(43) Pub. Date: Jun. 4, 2026

(54) DATA-DRIVEN INTRA-PREDICTION

(71) Applicant: GOOGLE LLC, Mountain View, CA (US)

(72) Inventors: Joseph Young, Mountain View, CA (US); Shan Li, Fremont, CA (US); In Suk Chong, Mountain View, CA (US); Raul Blazquez, Mountain View, CA (US)

(21) Appl. No.: 19/400,031

(22) Filed: Nov. 25, 2025

Related U.S. Application Data
(60) Provisional application No. 63/728,061, filed on Dec. 4, 2024.

(51) Int. Cl. H04N 19/105; H04N 19/159; H04N 19/176; H04N 19/70

(52) U.S. Cl. CPC H04N 19/105; H04N 19/159; H04N 19/176; H04N 19/70

(57) ABSTRACT

A data-driven intra-prediction mode is identified. Features are extracted from samples neighboring a current block. The features are processed based on the data-driven intra-prediction mode to obtain processed features. The processed features are converted into a matrix. A prediction block for the current block is generated based on the matrix. Extracting the features from the samples neighboring the current block includes selecting the samples at predefined fixed locations from neighboring reconstructed regions and deriving the features from the selected samples.

### CROSS REFERENCE TO RELATED APPLICATIONS

This application claims the benefit of and priority to U.S. Provisional Patent Application Ser. No. 63/728,061, filed Dec. 4, 2024, the entire disclosure of which is incorporated herein by reference.

### BACKGROUND

Digital video streams may represent video using a sequence of frames or still images. Digital video can be used for various applications including, for example, video conferencing, high definition video entertainment, video advertisements, or sharing of user-generated videos. A digital video stream can contain a large amount of data and consume a significant amount of computing or communication resources of a computing device for processing, transmission, or storage of the video data. Various approaches have been proposed to reduce the amount of data in video streams, including encoding or decoding techniques.

### SUMMARY

One aspect of the disclosed implementations relates to a method that includes identifying a data-driven intra-prediction mode; extracting features from samples neighboring a current block; processing the features based on the data-driven intra-prediction mode to obtain processed features; converting the processed features into a matrix; and generating a prediction block for the current block based on the matrix.

One aspect of the disclosed implementations relates to a device that includes a memory and a processor. The processor is configured to execute instructions stored in the memory to: identify a data-driven intra-prediction mode; extract features from samples neighboring a current block; process the features based on the data-driven intra-prediction mode to obtain processed features; convert the processed features into a matrix; and generate a prediction block for the current block based on the matrix.

One aspect of the disclosed implementations relate to a non-transitory computer-readable storage medium having stored thereon an encoded bitstream. The encoded bitstream includes: a syntax element indicating whether to use a data-driven intra-prediction mode for a current block; and a mode identifier specifying which data-driven intra-prediction mode to use. The encoded bitstream is decoded by operations that include extracting features from samples neighboring a current block; processing the features based on the data-driven intra-prediction mode to obtain processed features; converting the processed features into a matrix; and generating a prediction block for the current block based on the matrix.

These and other aspects of the present disclosure are disclosed in the following detailed description of the embodiments, the appended claims and the accompanying figures.

It will be appreciated that aspects can be implemented in any convenient form. For example, aspects may be implemented by appropriate computer programs which may be carried on appropriate carrier media which may be tangible carrier media (e.g. disks) or intangible carrier media (e.g. communications signals). Aspects may also be implemented using suitable apparatus which may take the form of programmable computers running computer programs arranged to implement the methods and/or techniques disclosed herein. Aspects can be combined such that features described in the context of one aspect may be implemented in another aspect.

### BRIEF DESCRIPTION OF THE DRAWINGS

The description herein makes reference to the accompanying drawings described below, wherein like reference numerals refer to like parts throughout the several views.

FIG. 1 is a schematic of a video encoding and decoding system.

FIG. 2 is a block diagram of an example of a computing device that can implement a transmitting station or a receiving station.

FIG. 3 is a diagram of a typical video stream to be encoded and subsequently decoded.

FIG. 4 is a block diagram of an encoder according to implementations of this disclosure.

FIG. 5 is a block diagram of a decoder according to implementations of this disclosure.

FIG. 6A is a flowchart of a technique for generating a prediction block for a current block using a data-driven intra-prediction.

FIG. 6B illustrates an example of an upsampling process.

FIG. 6C illustrates an example of a decimation and subsequent upsampling process.

FIG. 7 illustrates examples of deriving a feature vector based on neighboring samples.

FIG. 8 illustrates an example of signaling of data-driven intra-prediction modes.

FIG. 9 is a flowchart of a technique for generating a prediction block for a current block using a data-driven intra-prediction.

FIG. 10 is a flowchart of a technique for generating a prediction block for a current block using a data-driven intra-prediction.

### DETAILED DESCRIPTION

As mentioned above, compression schemes related to coding video streams may include breaking images into blocks and generating a digital video output bitstream (i.e., an encoded bitstream) using one or more techniques to limit the information included in the output bitstream. A received bitstream can be decoded to re-create the blocks and the source images from the limited information. Encoding a video stream, or a portion thereof, such as a frame or a block, can include using temporal or spatial similarities in the video stream to improve coding efficiency. For example, a current block of a video stream may be encoded based on identifying a difference (residual) between the previously coded pixel values, or between a combination of previously coded pixel values, and those in the current block.

Encoding using spatial similarities can be known as intra prediction. Intra prediction can attempt to predict the pixel values of a block of a frame of a video stream using pixels peripheral to the block; that is, using pixels that are in the same frame as the block but that are outside the block. A prediction block resulting from intra prediction is referred to herein as an intra predictor. Intra prediction can be performed along a direction of prediction where each direction can correspond to an intra prediction mode. The intra prediction mode can be signaled by an encoder to a decoder.

Implementations according to this disclosure further exploit spatial similarities via data-driven intra-prediction modes. The data-driven intra prediction modes described herein leverage (e.g., use) matrices, which may be machine learning-derived, to generate a prediction block. Specifically, when generating a prediction block for a current block, an initial set of input features is derived from neighboring samples of the current block. The input features are used to perform a matrix multiplication with pre-trained weights of one of the matrices, resulting in a fixed-size prediction block that may need to be subsequently resampled to match the dimensions of the current block.

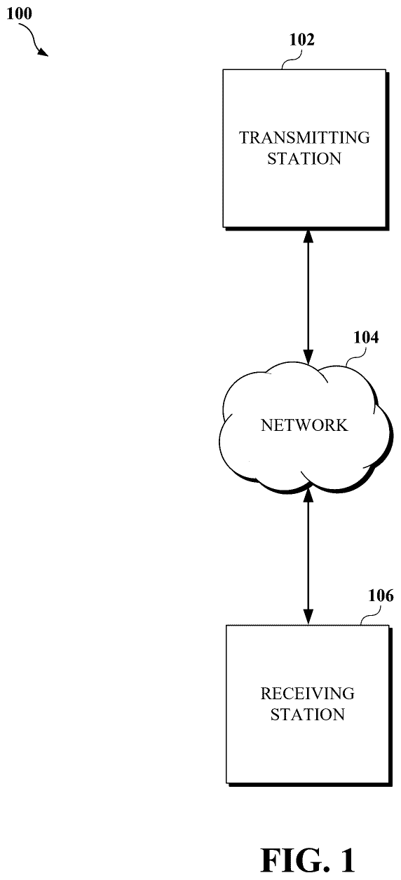

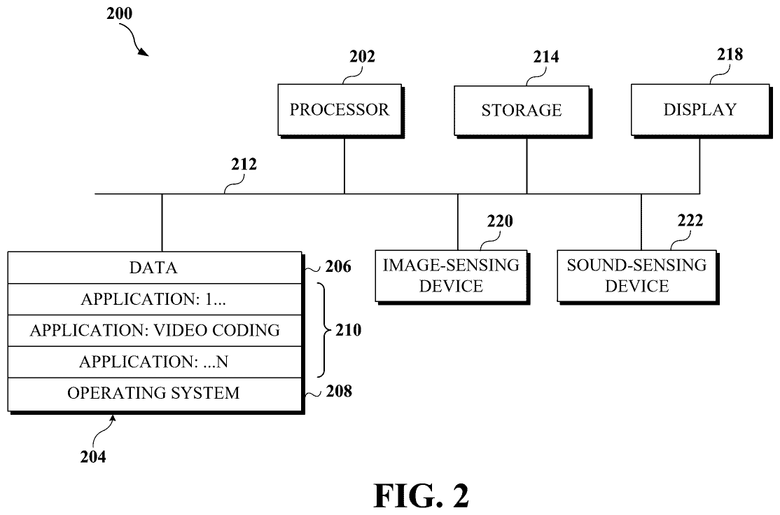

Further details of techniques for data-driven intra-prediction are described herein with initial reference to a system in which they can be implemented. FIG. 1 is a schematic of a video encoding and decoding system 100. A transmitting station 102 can be, for example, a computer having an internal configuration of hardware such as that described in FIG. 2. However, other implementations of the transmitting station 102 are possible. For example, the processing of the transmitting station 102 can be distributed among multiple devices.

A network 104 can connect the transmitting station 102 and a receiving station 106 for encoding and decoding of the video stream. Specifically, the video stream can be encoded in the transmitting station 102, and the encoded video stream can be decoded in the receiving station 106. The network 104 can be, for example, the Internet. The network 104 can also be a local area network (LAN), wide area network (WAN), virtual private network (VPN), cellular telephone network, or any other means of transferring the video stream from the transmitting station 102 to, in this example, the receiving station 106.

The receiving station 106, in one example, can be a computer having an internal configuration of hardware such as that described in FIG. 2. However, other suitable implementations of the receiving station 106 are possible. For example, the processing of the receiving station 106 can be distributed among multiple devices.

Other implementations of the video encoding and decoding system 100 are possible. For example, an implementation can omit the network 104. In another implementation, a video stream can be encoded and then stored for transmission at a later time to the receiving station 106 or any other device having memory. In one implementation, the receiving station 106 receives (e.g., via the network 104, a computer bus, and/or some communication pathway) the encoded video stream and stores the video stream for later decoding. In an example implementation, a real-time transport protocol (RTP) is used for transmission of the encoded video over the network 104. In another implementation, a transport protocol other than RTP may be used (e.g., a Hypertext Transfer Protocol-based (HTTP-based) video streaming protocol).

When used in a video conferencing system, for example, the transmitting station 102 and/or the receiving station 106 may include the ability to both encode and decode a video stream as described below. For example, the receiving station 106 could be a video conference participant who receives an encoded video bitstream from a video conference server (e.g., the transmitting station 102) to decode and view and further encodes and transmits his or her own video bitstream to the video conference server for decoding and viewing by other participants.

FIG. 2 is a block diagram of an example of a computing device 200 that can implement a transmitting station or a receiving station. For example, the computing device 200 can implement one or both of the transmitting station 102 and the receiving station 106 of FIG. 1. The computing device 200 can be in the form of a computing system including multiple computing devices, or in the form of one computing device, for example, a mobile phone, a tablet computer, a laptop computer, a notebook computer, a desktop computer, and the like.

A processor 202 in the computing device 200 can be a conventional central processing unit. Alternatively, the processor 202 can be another type of device, or multiple devices, capable of manipulating or processing information now existing or hereafter developed. For example, although the disclosed implementations can be practiced with one processor as shown (e.g., the processor 202), advantages in speed and efficiency can be achieved by using more than one processor.

A memory 204 in computing device 200 can be a read only memory (ROM) device or a random access memory (RAM) device in an implementation. However, other suitable types of storage device can be used as the memory 204. The memory 204 can include code and data 206 that is accessed by the processor 202 using a bus 212. The memory 204 can further include an operating system 208 and application programs 210, the application programs 210 including at least one program that permits the processor 202 to perform the techniques described herein. For example, the application programs 210 can include applications 1 through N, which further include a video coding application that performs the techniques described herein. The computing device 200 can also include a secondary storage 214, which can, for example, be a memory card used with a mobile computing device. Because the video communication sessions may contain a significant amount of information, they can be stored in whole or in part in the secondary storage 214 and loaded into the memory 204 as needed for processing.

The computing device 200 can also include one or more output devices, such as a display 218. The display 218 may be, in one example, a touch sensitive display that combines a display with a touch sensitive element that is operable to sense touch inputs. The display 218 can be coupled to the processor 202 via the bus 212. Other output devices that permit a user to program or otherwise use the computing device 200 can be provided in addition to or as an alternative to the display 218. When the output device is or includes a display, the display can be implemented in various ways, including by a liquid crystal display (LCD), a cathode-ray tube (CRT) display, or a light emitting diode (LED) display, such as an organic LED (OLED) display.

The computing device 200 can also include or be in communication with an image-sensing device 220, for example, a camera, or any other image-sensing device 220 now existing or hereafter developed that can sense an image such as the image of a user operating the computing device 200. The image-sensing device 220 can be positioned such that it is directed toward the user operating the computing device 200. In an example, the position and optical axis of the image-sensing device 220 can be configured such that the field of vision includes an area that is directly adjacent to the display 218 and from which the display 218 is visible.

The computing device 200 can also include or be in communication with a sound-sensing device 222, for example, a microphone, or any other sound-sensing device now existing or hereafter developed that can sense sounds near the computing device 200. The sound-sensing device 222 can be positioned such that it is directed toward the user operating the computing device 200 and can be configured to receive sounds, for example, speech or other utterances, made by the user while the user operates the computing device 200.

Although FIG. 2 depicts the processor 202 and the memory 204 of the computing device 200 as being integrated into one unit, other configurations can be utilized. The operations of the processor 202 can be distributed across multiple machines (wherein individual machines can have one or more processors) that can be coupled directly or across a local area or other network. The memory 204 can be distributed across multiple machines such as a network-based memory or memory in multiple machines performing the operations of the computing device 200. Although depicted here as one bus, the bus 212 of the computing device 200 can be composed of multiple buses. Further, the secondary storage 214 can be directly coupled to the other components of the computing device 200 or can be accessed via a network and can comprise an integrated unit such as a memory card or multiple units such as multiple memory cards. The computing device 200 can thus be implemented in a wide variety of configurations.

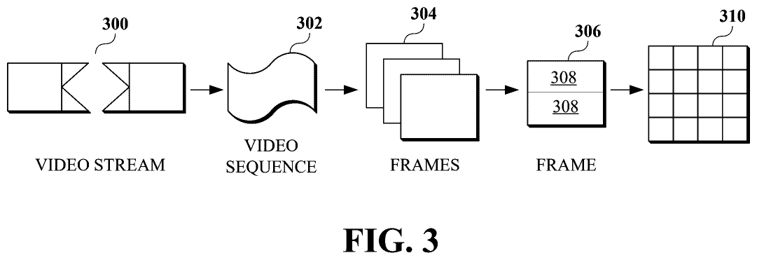

FIG. 3 is a diagram of an example of a video stream 300 to be encoded and subsequently decoded. The video stream 300 includes a video sequence 302. At the next level, the video sequence 302 includes a number of adjacent frames 304. While three frames are depicted as the adjacent frames 304, the video sequence 302 can include any number of adjacent frames 304. The adjacent frames 304 can then be further subdivided into individual frames, for example, a frame 306. At the next level, the frame 306 can be divided into a series of planes or segments 308. The segments 308 can be subsets of frames that permit parallel processing, for example. The segments 308 can also be subsets of frames that can separate the video data into separate colors. For example, a frame 306 of color video data can include a luminance plane and two chrominance planes. The segments 308 may be sampled at different resolutions.

Whether or not the frame 306 is divided into segments 308, the frame 306 may be further subdivided into blocks 310, which can contain data corresponding to, for example, 16×16 pixels in the frame 306. The blocks 310 can also be arranged to include data from one or more segments 308 of pixel data. The blocks 310 can also be of any other suitable size such as 4×4 pixels, 8×8 pixels, 16×8 pixels, 8×16 pixels, 16×16 pixels, or larger. Unless otherwise noted, the terms block and macroblock are used interchangeably herein.

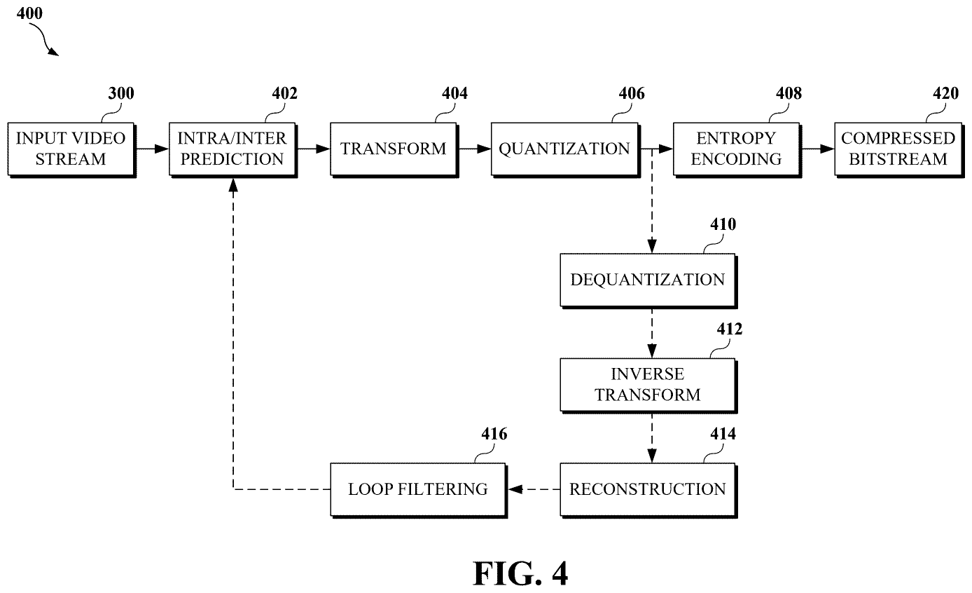

FIG. 4 is a block diagram of an encoder 400 according to implementations of this disclosure. The encoder 400 can be implemented, as described above, in the transmitting station 102, such as by providing a computer software program stored in memory, for example, the memory 204. The computer software program can include machine instructions that, when executed by a processor such as the processor 202, cause the transmitting station 102 to encode video data in the manner described in FIG. 4. The encoder 400 can also be implemented as specialized hardware included in, for example, the transmitting station 102. In one particularly desirable implementation, the encoder 400 is a hardware encoder.

The encoder 400 has the following stages to perform the various functions in a forward path (shown by the solid connection lines) to produce an encoded or compressed bitstream 420 using the video stream 300 as input: an intra/inter prediction stage 402, a transform stage 404, a quantization stage 406, and an entropy encoding stage 408. The encoder 400 may also include a reconstruction path (shown by the dotted connection lines) to reconstruct a frame for encoding of future blocks. In FIG. 4, the encoder 400 has the following stages to perform the various functions in the reconstruction path: a dequantization stage 410, an inverse transform stage 412, a reconstruction stage 414, and a loop filtering stage 416. Other structural variations of the encoder 400 can be used to encode the video stream 300.

When the video stream 300 is presented for encoding, respective adjacent frames 304, such as the frame 306, can be processed in units of blocks. At the intra/inter prediction stage 402, respective blocks can be encoded using intra-frame prediction (also called intra-prediction) or inter-frame prediction (also called inter-prediction). In any case, a prediction block can be formed. In the case of intra-prediction, a prediction block may be formed from samples in the current frame that have been previously encoded and reconstructed. In the case of inter-prediction, a prediction block may be formed from samples in one or more previously constructed reference frames.

Next, the prediction block can be subtracted from the current block at the intra/inter prediction stage 402 to produce a residual block (also called a residual). The transform stage 404 transforms the residual into transform coefficients in, for example, the frequency domain using block-based transforms. The quantization stage 406 converts the transform coefficients into discrete quantum values, which are referred to as quantized transform coefficients, using a quantizer value or a quantization level. For example, the transform coefficients may be divided by the quantizer value and truncated.

The quantized transform coefficients are then entropy encoded by the entropy encoding stage 408. The entropy-encoded coefficients, together with other information used to decode the block (which may include, for example, syntax elements such as used to indicate the type of prediction used, transform type, motion vectors, a quantizer value, or the like), are then output to the compressed bitstream 420. The compressed bitstream 420 can be formatted using various techniques, such as variable length coding (VLC) or arithmetic coding. The compressed bitstream 420 can also be referred to as an encoded video stream or encoded video bitstream, and the terms will be used interchangeably herein.

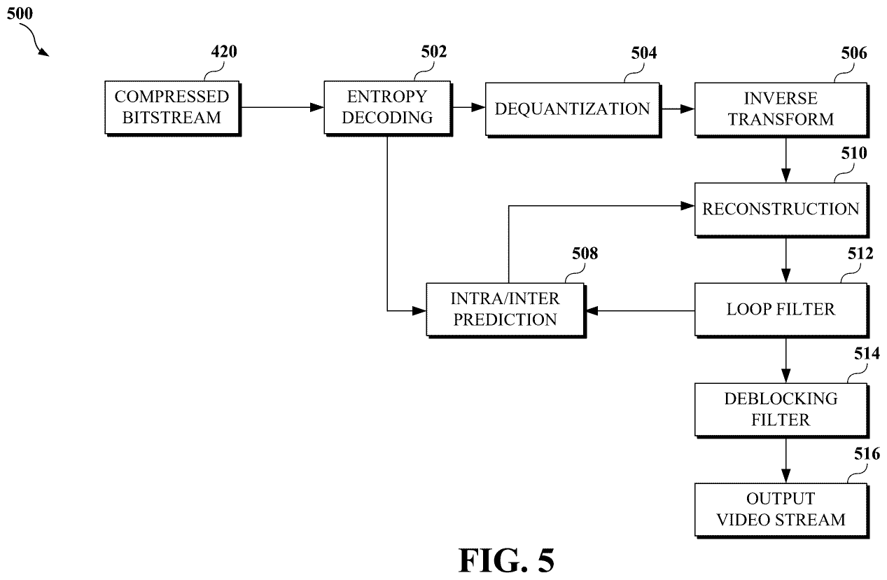

The reconstruction path (shown by the dotted connection lines) can be used to ensure that the encoder 400 and a decoder 500 (described below with respect to FIG. 5) use the same reference frames to decode the compressed bitstream 420. The reconstruction path performs functions that are similar to functions that take place during the decoding process (described below with respect to FIG. 5), including dequantizing the quantized transform coefficients at the dequantization stage 410 and inverse transforming the dequantized transform coefficients at the inverse transform stage 412 to produce a derivative residual block (also called a derivative residual). At the reconstruction stage 414, the prediction block that was predicted at the intra/inter prediction stage 402 can be added to the derivative residual to create a reconstructed block. The loop filtering stage 416 can be applied to the reconstructed block to reduce distortion such as blocking artifacts.

Other variations of the encoder 400 can be used to encode the compressed bitstream 420. In some implementations, a non-transform based encoder can quantize the residual signal directly without the transform stage 404 for certain blocks or frames. In some implementations, an encoder can have the quantization stage 406 and the dequantization stage 410 combined in a common stage.

FIG. 5 is a block diagram of a decoder 500 according to implementations of this disclosure. The decoder 500 can be implemented in the receiving station 106, for example, by providing a computer software program stored in the memory 204. The computer software program can include machine instructions that, when executed by a processor such as the processor 202, cause the receiving station 106 to decode video data in the manner described in FIG. 5. The decoder 500 can also be implemented in hardware included in, for example, the transmitting station 102 or the receiving station 106.

The decoder 500, similar to the reconstruction path of the encoder 400 discussed above, includes in one example the following stages to perform various functions to produce an output video stream 516 from the compressed bitstream 420: an entropy decoding stage 502, a dequantization stage 504, an inverse transform stage 506, an intra/inter prediction stage 508, a reconstruction stage 510, a loop filtering stage 512, and a deblocking filtering stage 514. Other structural variations of the decoder 500 can be used to decode the compressed bitstream 420.

When the compressed bitstream 420 is presented for decoding, the data elements within the compressed bitstream 420 can be decoded by the entropy decoding stage 502 to produce a set of quantized transform coefficients. The dequantization stage 504 dequantizes the quantized transform coefficients (e.g., by multiplying the quantized transform coefficients by the quantizer value), and the inverse transform stage 506 inverse transforms the dequantized transform coefficients to produce a derivative residual that can be identical to that created by the inverse transform stage 412 in the encoder 400. Using header information decoded from the compressed bitstream 420, the decoder 500 can use the intra/inter prediction stage 508 to create the same prediction block as was created in the encoder 400 (e.g., at the intra/inter prediction stage 402).

At the reconstruction stage 510, the prediction block can be added to the derivative residual to create a reconstructed block. The loop filtering stage 512 can be applied to the reconstructed block to reduce blocking artifacts. Other filtering can be applied to the reconstructed block. In this example, the deblocking filtering stage 514 is applied to the reconstructed block to reduce blocking distortion, and the result is output as the output video stream 516. The output video stream 516 can also be referred to as a decoded video stream, and the terms will be used interchangeably herein. Other variations of the decoder 500 can be used to decode the compressed bitstream 420. In some implementations, the decoder 500 can produce the output video stream 516 without the deblocking filtering stage 514.

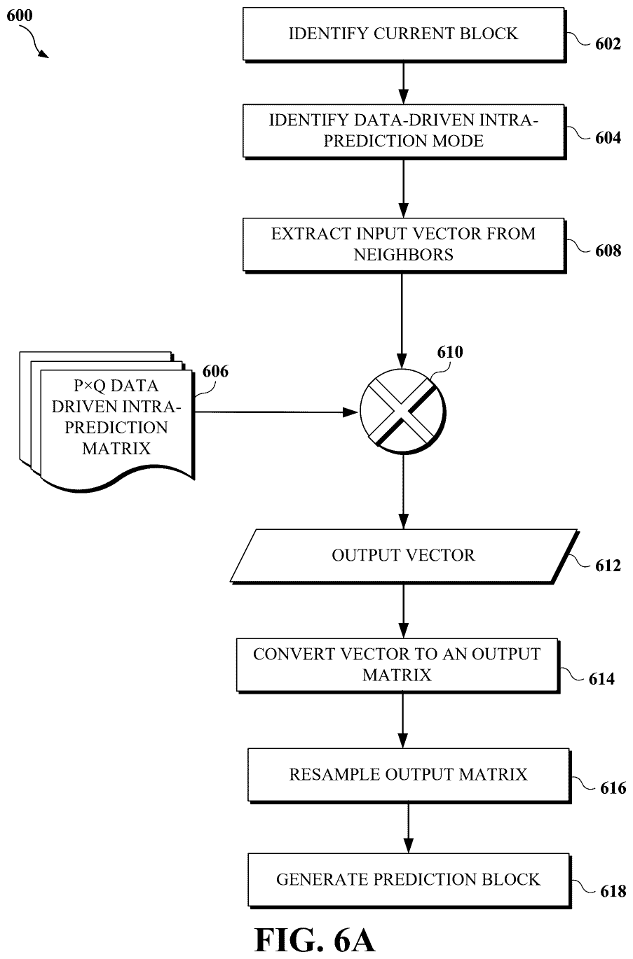

FIG. 6A is a flowchart of a technique 600 for generating a prediction block for a current block using a data-driven intra-prediction. The technique 600 can be implemented, for example, as a software program that may be executed by computing devices such as transmitting station 102 or receiving station 106. The software program can include machine-readable instructions that may be stored in a memory such as the memory 204 or the secondary storage 214, and that, when executed by a processor, such as the processor 202, may cause the computing device to perform the technique 600. The technique 600 may be implemented in whole or in part in the intra/inter prediction stage 402 of the encoder 400 of FIG. 4 and/or the intra/inter prediction stage 508 of the decoder 500 of FIG. 5. When implemented by an encoder, coding means encoding, as described with respect to FIG. 4; and when implemented by a decoder, coding means decoding, as described with respect to FIG. 5. The technique 600 can be implemented using specialized hardware or firmware. Multiple processors, memories, or both, may be used.

At 602, the current block is identified as the block for which a prediction block is to be generated. At 604, a data-driven intra-prediction mode is identified for generating the prediction block. When implemented by the encoder, the technique 600 may identify the data-driven intra-prediction mode based on rate-distortion optimization. Rate-distortion (R-D) optimization represents the fundamental trade-off between compression efficiency (rate, measured in bits) and quality loss (distortion) in video encoding. This optimization process is typically formulated using a Lagrangian cost function: J=D+λR, where J is the cost to minimize, D is the distortion (quality loss), R is the rate (bits), and λ (lambda) is the Lagrangian multiplier that weights the relative importance of rate versus distortion. The optimization process occurs at multiple levels in the encoding pipeline, including coding unit decisions, transform selections, and quantization parameters.

When selecting between available coding modes (such as intra prediction, inter prediction, and data-driven intra-prediction), the encoder calculates distortion using metrics like Sum of Absolute Differences (SAD), determines the rate including both mode signaling and residual coding bits, and computes the combined R-D cost. For computational efficiency, the encoder may employ various optimization strategies including early termination of mode searches, content-aware mode filtering, adaptive thresholds to skip testing unlikely modes, and statistical tracking of mode usage patterns, ultimately selecting the mode that minimizes the R-D cost function while respecting bitrate and quality constraints. With respect to data-driven intra-prediction modes, the encoder may select one (i.e., the data-driven intra-prediction mode) of the data-driven intra-prediction modes based on the rate-distortion optimization.

The encoder may implement pruning strategies to reduce the computational burden of evaluating all data-driven intra-prediction modes. For example, the encoder may implement heuristic evaluation logic, or other intra-prediction mode evaluation logic implemented by the encoder, to identify promising candidate modes before fully evaluating each data-driven intra-prediction mode. The pruning may involve early termination when the rate-distortion cost of a partially evaluated mode exceeds a threshold relative to the best mode found so far.

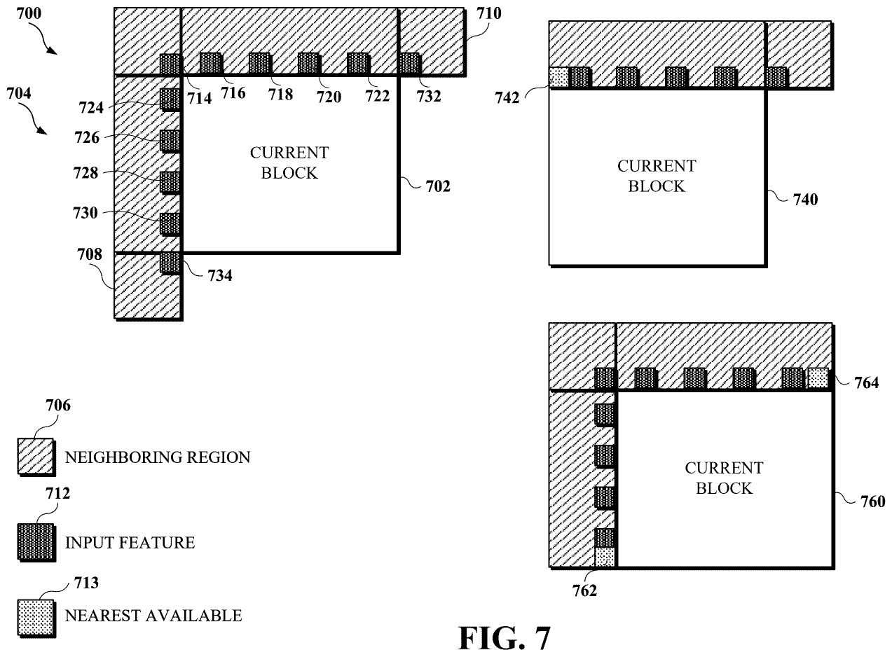

When implemented by the decoder, the technique 600 identifies the data-driven intra-prediction mode by decoding syntax elements from the compressed bitstream. The decoder first decodes a flag (use_data_driven_intra) indicating whether data-driven intra-prediction is used for the current block. If the flag indicates that data-driven intra-prediction is used, the decoder then decodes the data_driven_intra_mode syntax element identifying which of the available matrices to use (e.g., one of six matrices). The decoder may also decode a transpose flag indicating whether the input features should be transposed before matrix multiplication. The decoding process may use context-adaptive binary arithmetic coding with context modeling as described with respect to FIG. 8. Once the syntax elements are decoded, the decoder selects the corresponding matrix from its stored set of pre-trained matrices and applies it as described in subsequent steps.

A data-driven intra-prediction mode may identify a matrix 606, which is a set of weights. The codec (e.g., the encoder and/or the decoder) may include several matrices, each corresponding to a respective data-driven intra-prediction mode. For example, the codec may include six matrices, providing six data-driven intra-prediction modes. Each matrix may have dimensions selected to accommodate a fixed number of input features while producing an output of predetermined dimensions (e.g., generating an 8×8 output matrix). More generally, each matrix may be of size P×Q, where P corresponds to the number of input features derived from the neighboring samples of the current block and Q is a perfect square enabling square matrix conversion. In an example, eleven input features (P=11) can be derived from neighboring samples, resulting in a matrix of size 11×64 (where Q=64).

The data-driven matrices may be generated through a training process using machine learning techniques. A machine learning model may be trained using a dataset of video frames to optimize prediction accuracy while maintaining a compact representation suitable for codec implementation. The training process may include analyzing correlation patterns between neighboring samples and prediction outcomes across diverse video content. The trained matrices may be selected to minimize prediction error metrics such as sum of squared differences (SSD) or other distortion measures. Once trained, the matrices may be fixed as constants within the codec implementation, with the same matrices used by both encoder and decoder.

In some implementations, the effective number of data-driven intra-prediction modes may be doubled by selectively transposing the input features before matrix multiplication, effectively creating 2N distinct prediction modes from N trained matrices (e.g., twelve modes from six matrices). As such, the prediction mode associated with the current block may include both a data-driven intra-prediction mode identifier and a transpose flag indicating whether the input features are transposed prior to matrix multiplication. When the transpose flag is set, the input features derived from samples above the current block are swapped with corresponding input features derived from samples to the left of the current block before performing the matrix multiplication.

As described further at 616, after the matrix multiplication and conversion to the output matrix, when the transpose flag is set, the output matrix itself is also transposed during the resampling operation. This transposition mechanism exploits the natural symmetry between vertical and horizontal features in image data, allowing each trained matrix to effectively serve two distinct prediction modes without requiring additional matrix storage.

The encoder encodes, as described with respect to FIG. 8, the data-driven intra-prediction mode in a compressed bitstream, such as the compressed bitstream 420 of FIG. 4. In some implementations, the encoder may also encode the transpose flag. As such, when the technique 600 is implemented by the decoder, the technique 600 identifies the data-driven intra-prediction mode by decoding the mode from a compressed bitstream, such as the compressed bitstream 420 of FIG. 5. The decoding process, which mirrors the encoding process described with respect to FIG. 8, includes decoding the data-driven intra-prediction mode and, when applicable, decoding the transpose flag.

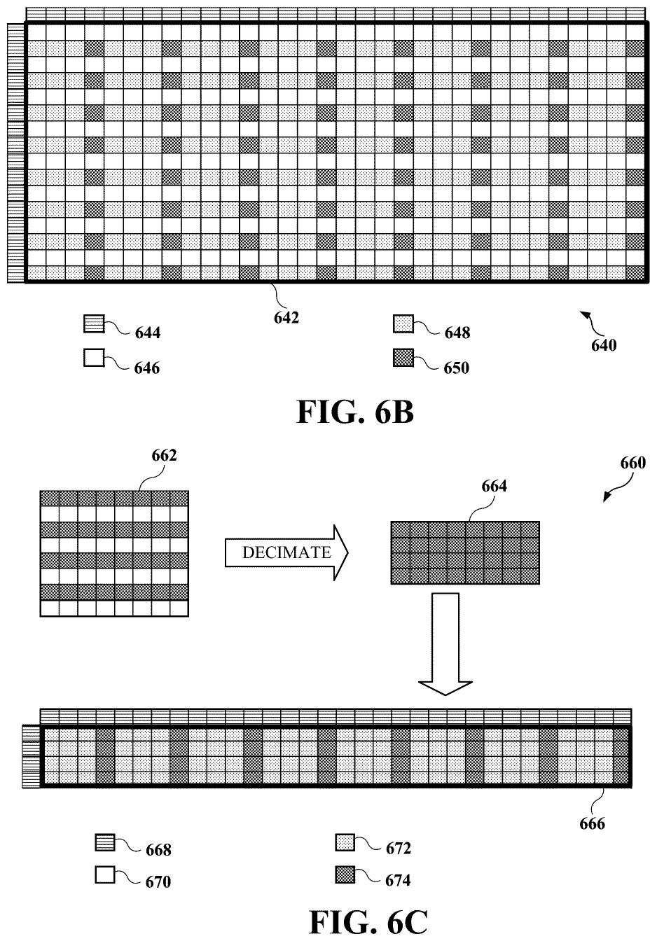

At 608, an input vector of features is extracted (e.g., derived) from samples neighboring the current block. The number of features is based on the size of the data-driven matrix. As mentioned above, the data-driven matrix can have a size of P×Q. As such, P features are derived. The input vector is 1×P row vector. Deriving the features for the input vector is described with respect to FIG. 7.

At 610, the input vector of features is multiplied by the data-driven matrix to obtain an output vector 612. Given an input vector \vec{v} of features of size 1×P and a data-driven matrix M of size P×Q, the matrix multiplication produces an output vector \vec{o} of size 1×Q. For example, if the data-driven matrices are each of size 11×64, and the input vector is of size 1×11, then the output vector would be of size 1×64.

At 614, the output vector 612 is converted to an output matrix. The output vector 612 is converted to the output matrix by reshaping the 1×Q vector into a square matrix. For example, when Q=64, the 1×64 output vector is reshaped into an 8×8 matrix by sequentially filling the matrix row by row with elements from the output vector 612. Specifically, the first 8 elements of the output vector 612 become the first row of the output matrix, the next 8 elements become the second row, and so on, until all 64 elements have been arranged into the 8×8 output matrix. This reshaping process preserves the order of elements while transforming them into a two-dimensional prediction block format suitable for subsequent processing. As such, Q may be a perfect square (e.g., 64=82) to enable a square matrix conversion.

At 616, the output matrix is resampled, if necessary, to adapt it for generating the prediction block at 618. Whether the resampling process is performed depends on the relationship between the fixed-size output matrix (e.g., 8×8) and the dimensions of the current block (W×H). When dimensions match, the output matrix is used directly; when they differ, resampling operations transform the output matrix to match the target dimensions. When the transpose flag is set, the output matrix is first transposed before performing any dimension-based processing. The transposition involves swapping the rows and columns of the output matrix, such that an element at position (i, j) in the original output matrix is moved to position (j, i) in the transposed output matrix. This transposition, when applied, enables the same trained matrix to effectively generate predictions in both vertical and horizontal orientations.

The resampling can be performed separately along each dimension. In some implementations, the vertical dimension (height H) may be processed first, followed by the horizontal dimension (width W). Other implementations may reverse this order. The resampling process for each dimension depends on the relationship between the target dimension and the output matrix dimension.

When a target dimension is greater than the corresponding output matrix dimension (e.g., when W or H is greater than 8), upsampling is performed using linear interpolation that incorporates both pixels from the output matrix and reconstructed neighboring pixels of the current block. FIG. 6B illustrates an example of the upsampling process. For example, when upsampling the horizontal dimension, the interpolation utilizes pixels from both the output matrix and the reconstructed samples in the above neighboring region. Similarly, when upsampling the vertical dimension, the interpolation may utilize pixels from both the output matrix and the reconstructed samples in the left neighboring region. When the neighboring pixels are not available (such as at frame boundaries, tile boundaries, or other regions where reconstructed samples have not yet been generated), the closest available reconstructed pixel is replicated across the unavailable region, similar to the approach used in directional intra prediction modes.

The linear interpolation coefficients may have power-of-two denominators to enable efficient fixed-point arithmetic operations. Specifically, when upsampling from 8 pixels to 16 pixels, the denominator is 2; when upsampling to 32 pixels, the denominator is 4; and when upsampling to 64 pixels, the denominator is 8, with numerators ranging between 1 and 7. The linear interpolation may be implemented using equation (1), in which the direct neighbors are x₀ and xₙ, with N being a power of 2. From these two neighbors, the intermediate pixels xᵢ for i=1, . . . , N−1 can be obtained as follows, where trunc( ) indicates truncation:

$${x}_{i} = trunc ( \frac{( N - i ) {x}_{0} + i \cdot {x}_{N}}{N} ) \qquad ( 1 )$$

This power-of-two structure allows the interpolation to be implemented using bit-shift operations rather than division, improving computational efficiency particularly in hardware implementations.

When a target dimension equals the corresponding output matrix dimension (e.g., when W or H equals 8), the output matrix dimension along that axis is used unmodified, and no resampling is performed for that dimension. The pixels from the output matrix are directly used as the prediction values along that dimension.

When a target dimension is less than the corresponding output matrix dimension (e.g., when W or H is less than 8), downsampling is performed using decimation. FIG. 6C illustrates an example of the decimation and subsequent upsampling process. The decimation process selects a subset of pixels from the output matrix while discarding others. For example, when downsampling from 8 pixels to 4 pixels along a dimension, alternating pixels may be selected (such as pixels at positions 0, 2, 4, and 6) while the intermediate pixels (at positions 1, 3, 5, and 7) are eliminated. The specific decimation pattern may be predetermined or may be selected based on the target dimension. After decimation along the applicable dimension(s), if the decimated dimension still requires adjustment to reach the target dimension, upsampling using the interpolation approach described above may be applied to the decimated output to reach the final target dimension, incorporating the reconstructed neighboring pixels as appropriate.

This dimension-by-dimension resampling approach allows flexible adaptation of the fixed-size output matrix to match any target block dimensions while maintaining prediction quality. The integration of neighboring reconstructed samples during interpolation helps ensure spatial continuity between the predicted block and its surrounding context, which can improve coding efficiency by reducing prediction residuals.

At 618, the prediction block for the current block is generated based on the resampled output matrix. The resampled output matrix, now matching the dimensions W×H of the current block, serves as the prediction block. This prediction block can then be used in the encoding or decoding process, such as by subtracting it from the current block to generate a residual (in encoding) or by adding it to a decoded residual to reconstruct the current block (in decoding).

In some implementations, the matrix weights may be quantized to reduce memory requirements and computational complexity. For example, the weights may be quantized to 12-bit fixed-point values, which can reduce storage requirements while maintaining prediction accuracy. Such quantization may be performed during a training phase or as a post-processing step after training. The quantized weights can provide substantially similar coding performance to floating-point weights while enabling more efficient hardware implementations.

In an example, data-driven intra-prediction modes may only be available for current blocks that are larger than or equal to a certain threshold size. Assuming the current block has a size of W×H (i.e., a width of W and a height of H), then the data-driven intra-prediction modes may only be available for blocks where W*H≥Threshold size (e.g., 128). This size-based restriction serves two purposes. First, it aids hardware implementation efficiency, as processing smaller blocks typically represents a bottleneck in hardware implementations. By limiting data-driven intra-prediction modes to larger blocks, the implementation avoids adding computational complexity to these performance-critical paths. Second, experimental results indicate that the coding gains from these data-driven intra-prediction modes are most significant for larger block sizes, making this restriction both practically efficient and coding-effective.

In some implementations, the data-driven intra-prediction modes may only be available for luma (Y component) blocks and may not be available for chroma (U and V component) blocks. In other implementations, the data-driven intra-prediction modes may be available for both luma and chroma blocks. When data-driven intra-prediction modes are applied to chroma blocks, the size threshold and matrix operations may be adapted based on the chroma subsampling format of the video content.

For example, in 4:4:4 format where chroma components have the same resolution as luma, a chroma block may use the same size threshold (such as W×H≥128) as luma blocks. In 4:2:2 format where chroma components are horizontally subsampled by a factor of two, a chroma block of dimensions W_{c}×H_{c} may satisfy the threshold when W_{c}×H_{c}≥64 (accounting for the halved horizontal resolution), or alternatively may use the same threshold of W_{c}×H_{c}≥128 as luma blocks. In 4:2:0 format where chroma components are subsampled by a factor of two in both horizontal and vertical dimensions, a chroma block of dimensions W_{c}×H_{c} may satisfy the threshold when W_{c}×H_{c}≥32 (accounting for the quarter total resolution), or alternatively may use the same threshold of W_{c}×H_{c}≥128 as luma blocks. The threshold may be adjusted to account for the different spatial resolutions while maintaining similar computational characteristics across color components.

FIG. 6B illustrates an example 640 of an upsampling process as may be performed at 616 of FIG. 6A. The example 640 shows the result of upsampling a fixed-size output matrix to match larger block dimensions. A prediction block 642 includes pixels of different types, distinguished by their fill patterns. Pixels with pattern 644 represent reconstructed neighboring pixels from the left neighboring regions. Pixels with pattern 646 represent pixels that are linearly interpolated using two direct neighbors in the vertical direction. Pixels with pattern 648 represent pixels that are linearly interpolated using two direct neighbors in the horizontal direction. Pixels with pattern 650 represent pixel components derived directly from the output vector (converted to the output matrix at 614 of FIG. 6A). The example 640 illustrates how the upsampling process creates a pattern where direct pixels from the output matrix are combined with interpolated pixels, with interpolation incorporating both output matrix pixels and reconstructed neighboring pixels to ensure spatial continuity.

FIG. 6C illustrates an example 660 of a decimation and subsequent upsampling process as may be performed at 616 of FIG. 6A when a target dimension is less than the output matrix dimension. An output matrix 662 (e.g., 8×8) undergoes decimation to produce a decimated matrix 664 (e.g., 4×4), where alternating pixels are selected while intermediate pixels are eliminated. The decimated matrix 664 is then upsampled to match the target block dimensions, resulting in a prediction block 666. The prediction block 666 includes pixels of different types, distinguished by their fill patterns.

Pixels with pattern 668 represent reconstructed neighboring pixels from the neighboring region. Pixels with pattern 670 represent pixel components of the output vector that are eliminated during the decimation process. Pixels with pattern 672 represent pixels that are linearly interpolated using two direct neighbors in the horizontal direction. Pixels with pattern 674 represent pixel components of the output vector that are retained through the decimation process. The example 660 demonstrates how decimation reduces the output matrix size before upsampling combines the retained pixels with interpolated pixels and reconstructed neighboring pixels to generate the final prediction block.

FIG. 7 illustrates examples 700 of deriving a feature vector based on neighboring samples. The number of features is equal to P (e.g., 11). The examples 700 include a current block 702. A neighboring region 704 includes any available reconstructed left and above regions. The neighboring regions are shown in a pattern 706. The neighboring region 704 illustrates that the left neighboring region 708 and the above neighboring region 710 are available. The features are derived using the P samples from the neighboring region 704. The samples (i.e., pixels) used to derive the features are shown in a pattern 712.

In an example, the samples include: 1 corner feature (f₀) (i.e., a sample 714), 4 above features (f₁-f₄) (i.e., samples 716, 718, 720, 722) derived from pixels in the above neighboring region, 4 left features (f₅-f₈) (i.e., samples 724, 726, 728, 730) derived from pixels in the left neighboring region, 1 above-right overhang feature (f₉) (i.e., a sample 732) from an overhang region extending beyond the width W of the above neighboring region 710, and 1 bottom-left overhang feature (f₁₀) (i.e., a sample 734) from an overhang region extending beyond the height H of the left neighboring region 708. The above-right overhang region extends beyond the width W of the current block by an overhang length O1, and the bottom-left overhang region extends beyond the height H of the current block by an overhang length O2. In some implementations, O1 may equal W/4 and O2 may equal H/4, such that the total horizontal extent of pixels used for feature extraction is W plus O1 and the total vertical extent is H plus O2. Different ways are available for selecting the neighboring samples. For example, the samples may be selected at a predefined fixed locations from the neighboring regions and overhang regions.

In certain circumstances, at least some of these samples may not be available. For example, with respect to a current block 740, only the top neighboring region is available; and with respect to a current block 760, the neighboring regions that would otherwise include the above-right overhang (f₉) and the bottom-left overhang (f₁₀) are not available. In such cases, any unavailable samples can be replaced with nearest (to the missing sample) available neighbors. Examples of nearest available neighbors are illustrated using a pattern 713. With respect to the current block 740, six neighboring samples are unavailable and are replaced with a six copies of a nearest neighbor 742. With respect to the current block 760, nearest neighbors 762 and 764 are used. In an example, the nearest available neighbor can be one of other samples used for generating the features. To illustrate, assuming that the sample 734 is unavailable, then the nearest available neighbor may be the sample 730. When all neighboring regions of the current block are unavailable (for example, when the current block is at the top-left corner of a frame or segment with no previously reconstructed samples), all features in the input vector may be set to a fixed middle-range sample value, such as a value corresponding to mid-gray in the applicable bit depth (for example, 128 for 8-bit samples or 512 for 10-bit samples).

The features of the input vector can be obtained from the selected samples in any number of ways. In an example, the samples themselves are used as the features of the input vector. In an example, each feature can be obtained as a respective weighted average of a subset of the selected neighboring samples.

More specifically, for the above features, the feature extraction process uses a pixel vector comprising the above pixels and the right overhang (W+O1 pixels total). These pixels may be processed as follows: the W pixels from the above neighboring region 710 may be divided into a plurality of groups (e.g., 4 groups) of contiguous pixels each (e.g., W/4 pixels per group), and each of the plurality of above features (e.g., f1-f4) may be obtained by averaging or otherwise combining the pixels within its corresponding group. For example, when W=8, groups of 2 pixels (W/4=2) may be averaged to obtain each feature; when W=32, groups of 8 pixels (W/4=8) may be averaged together. The above-right overhang feature (f9) may be obtained from the O1 overhang pixels extending beyond the above neighboring region through averaging, sampling, or other feature extraction techniques.

Similarly, for the left features, the feature extraction process uses a pixel vector comprising the left pixels and the bottom overhang (H+O2 pixels total). These pixels may be processed as follows: the H pixels from the left neighboring region 708 may be divided into a plurality of groups (e.g., 4 groups) of contiguous pixels each (e.g., H/4 pixels per group), and each of the plurality of left features (e.g., f5-f8) may be obtained by averaging or otherwise combining the pixels within its corresponding group. For example, when H=8, groups of 2 pixels (H/4=2) may be averaged to obtain each feature; when H=32, groups of 8 pixels (H/4=8) may be averaged together. The bottom-left overhang feature (f10) may be obtained from the O2 overhang pixels extending beyond the left neighboring region through averaging, sampling, or other feature extraction techniques.

The averaging for features f1-f4 and f5-f8 may be performed using equation (2), where the summation is over all pixels in the corresponding group, and D is a value based on the group size (e.g., W/4 for above features or H/4 for left features). In some implementations, when W equals 4 or H equals 4, the pixels in the corresponding dimension may be used directly as features without averaging. In other implementations, alternative grouping schemes or feature extraction methods may be employed based on the block dimensions or other encoding parameters.

$$feature = round ( \frac{{\sum }_{i}^{D} {pixel}_{i}}{D} ) with D being \frac{W}{4} or \frac{H}{4} \qquad ( 2 )$$

The order of features in the input vector may depend on whether transposition is applied. When the transpose flag is not set (direct order), the input vector may contain features in the following order: the corner pixel feature, followed by the four above pixel features (f1-f4), followed by the right overhang feature (f9), followed by the four left pixel features (f5-f8), and ending with the bottom overhang feature (f10). This ordering is illustrated in a Table II.

TABLE II
Input Vector, Direct Order

| | | | | |
|---|---|---|---|---|
| Corner Pixel | f1-f4 | f9 | f5-f8 | f10 |

When the transpose flag is set (transposed order), the input vector may contain features in a different order: the corner pixel feature, followed by the four left pixel features (f5-f8), followed by the bottom overhang feature (f10), followed by the four above pixel features (f1-f4), and ending with the right overhang feature (f9). This ordering is illustrated in Table III.

TABLE III
Input Vector, Transposed Order

| | | | | |
|---|---|---|---|---|
| Corner Pixel | f5-f8 | f10 | f1-f4 | f9 |

In the transposed order, the spatial relationships from the vertical dimension (left and bottom) precede those from the horizontal dimension (above and right), effectively swapping the roles of horizontal and vertical features in the subsequent matrix multiplication. Regardless of whether the direct or transposed order is used, the input vector may have the same number of values F=11 for the block sizes considered.

FIG. 8 illustrates an example 800 of signaling of data-driven intra-prediction modes. Signaling, in this context, refers to what an encoder encodes, in a compressed bitstream, regarding the prediction mode of a current block and what a decoder decodes from the compressed bitstream. The signaling can include one or more syntax elements. The syntax elements can be encoded in a header of the current block.

In some implementations, when a data-driven intra-prediction mode is used for a current block, the block may be initially signaled with a primary intra-prediction mode indicator set to a specific directional mode (such as the DC prediction mode, which predicts all pixels using an average of neighboring samples) to indicate that additional mode information follows. The syntax elements described with respect to the example 800 include a use_data_driven_intra flag 802 indicating whether data-driven intra-prediction is used for the current block, a data_driven_intra_mode syntax element 804 identifying which of the available data-driven intra-prediction modes (i.e., matrices) is used when the use_data_driven_intra flag 802 is set, and a transpose flag 806 indicating whether the input features should be transposed prior to matrix multiplication as described above.

The transpose flag 806 may not be used in certain implementations. That is, transposition of input features may not be supported and, consequently, the number of available data-driven intra-prediction modes would be limited to the number of matrices (e.g., six) rather than being doubled through transposition (e.g., twelve). In such implementations, the transpose flag 806 would not be included in the signaling, and only the use_data_driven_intra flag 802 and data_driven_intra_mode syntax element 804 would be encoded in the compressed bitstream and subsequently decoded.

When entropy coding the syntax elements for data-driven intra-prediction modes, the encoder and decoder may employ context modeling to improve compression efficiency. For example, the use_data_driven_intra flag 802 may be entropy coded using a context-adaptive binary arithmetic coding approach with multiple contexts (such as three contexts). The context index for encoding or decoding the use_data_driven_intra flag 802 may be determined based on the number of neighboring blocks (such as the blocks immediately above and immediately to the left of the current block) that use data-driven intra-prediction modes. The data_driven_intra_mode syntax element 804 may be entropy coded using a single cumulative distribution function (CDF) that models the probability distribution across the available modes (such as six modes when transpose is handled separately).

Table I illustrates an example of a pseudocode for signaling data-driven intra-prediction mode information in a bitstream. The pseudocode shows a function data_driven_mode_info( ) that initializes use_data_driven_intra and data_driven_intra_mode to zero, then checks whether data-driven intra-prediction is allowed for the current block using data_driven_intra_allowed( ) If allowed, the use_data_driven_intra flag is decoded using context-adaptive binary arithmetic coding with a cumulative distribution function (CDF). When use_data_driven_intra is true, the data_driven_intra_mode is decoded using a CDF with six symbols (corresponding to six available matrices), followed by the transpose flag which is decoded using literal coding with one bit. In alternative implementations, the order of decoding data_driven_intra_mode and transpose may be reversed, with transpose decoded before data_driven_intra_mode.

TABLE I

| | Type |
|---|---|
| data_drive_mode_info( ) { | |
| use_data_driven_intra = 0 | |
| data_driven_intra_mode = 0 | |
| if (data_driven_intra_allowed( )) { | |
| use_data_driven_intra | CDF(1) |
| if (use_data_driven_intra) { | |
| data_driven_intra_mode | CDF(6) |
| transpose | L(1) |
| } | |
| } | |
| } | |

The use_data_driven_intra flag can be coded as a binary arithmetic-coded symbol using context-adaptive binary arithmetic coding with a first number (e.g., three) of contexts. The context index can be calculated based on the number of neighboring blocks (out of the two above and left context neighbors) that are using data-driven intra-prediction. Specifically, if neither neighboring block uses data-driven intra-prediction, the context index can be 0; if one neighboring block uses data-driven intra-prediction, the context index can be 1; and if both neighboring blocks use data-driven intra-prediction, the context index can be 2. The data_driven_intra_mode syntax element can be coded using a single cumulative distribution function (CDF) with six symbols, corresponding to the six available matrices. The context modeling for use_data_driven_intra requires three contexts with two symbols each, requiring 60 bits for context storage, while data_driven_intra_mode uses one context with six symbols, requiring 80 bits for context storage.

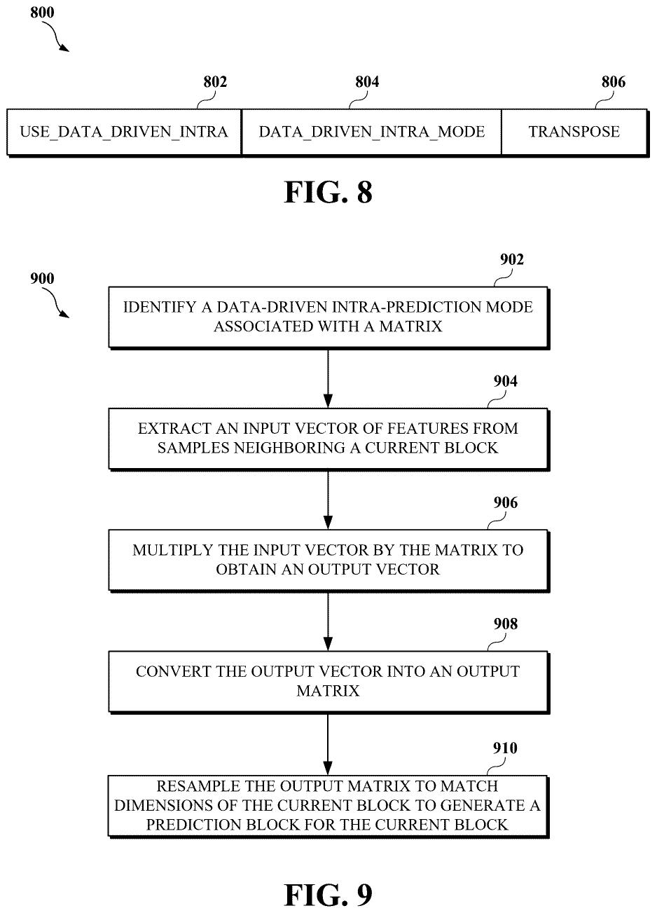

FIG. 9 is a flowchart of a technique 900 for generating a prediction block for a current block using a data-driven intra-prediction. The technique 900 can be implemented, for example, as a software program that may be executed by computing devices such as transmitting station 102 or receiving station 106. The software program can include machine-readable instructions that may be stored in a memory such as the memory 204 or the secondary storage 214, and that, when executed by a processor, such as the processor 202, may cause the computing device to perform the technique 900. The technique 900 may be implemented in whole or in part in the intra/inter prediction stage 402 of the encoder 400 of FIG. 4 and/or the intra/inter prediction stage 508 of the decoder 500 of FIG. 5. When implemented by an encoder, coding means encoding, as described with respect to FIG. 4; and when implemented by a decoder, coding means decoding, as described with respect to FIG. 5. The technique 900 can be implemented using specialized hardware or firmware. Multiple processors, memories, or both, may be used.

At 902, a data-driven intra-prediction mode associated with a matrix is identified. This identification can occur through decoding the mode from a compressed bitstream, when implemented by the decoder; or by selecting the mode based on rate-distortion optimization, when implemented by the encoder. The matrix may be one of several pre-trained matrices, such as six matrices generated using machine learning techniques, each corresponding to at least one respective data-driven intra-prediction mode.

At 904, an input vector of features is extracted from samples neighboring a current block. This extraction involves selecting neighboring samples at predefined fixed locations from neighboring reconstructed regions. The neighboring samples include a corner sample at an intersection of left and above neighboring regions, multiple samples from both above and left neighboring regions, a sample from an above-right overhang region, and a sample from a bottom-left overhang region. If any neighboring samples are unavailable, they are replaced with nearest available neighboring samples. Some features may be obtained as weighted averages of subsets of the neighboring samples.

At 906, the input vector is multiplied by the matrix to obtain an output vector. The matrix has dimensions P×Q, where P corresponds to the number of input features and Q is a perfect square, with specific implementations using P=11 and Q=64. Before multiplication, if a transpose flag is set, features derived from samples above the current block are swapped with features derived from samples to the left. At 908, the output vector is converted into an output matrix through a reshaping process.

At 910, the output matrix is resampled to match dimensions of the current block to generate a prediction block. When the transpose flag is set, the output matrix is transposed before performing the resampling. This resizing involves dimension-by-dimension processing, including upsampling when a target dimension is greater than the corresponding output matrix dimension, downsampling when it is less, and maintaining the dimension when they are equal. The upsampling may incorporate both pixels from the output matrix and reconstructed neighboring pixels of the current block.

The technique 900 may only be performed when the dimensions of the current block are greater than or equal to a threshold size, such as 128 samples. The data-driven intra-prediction mode may be encoded in a compressed bitstream using various syntax elements including a flag indicating whether data-driven intra-prediction is used, a syntax element identifying which mode is used, and another flag indicating whether input features should be transposed.

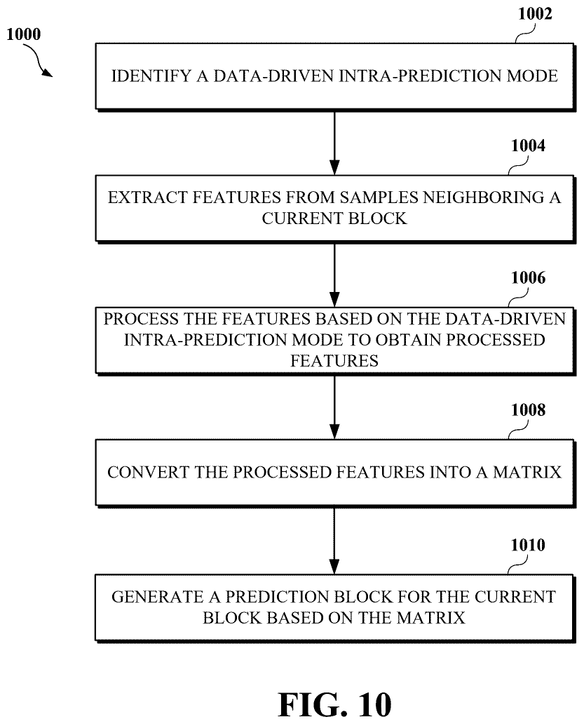

FIG. 10 is a flowchart of a technique 1000 for generating a prediction block for a current block using a data-driven intra-prediction. The technique 1000 can be implemented, for example, as a software program that may be executed by computing devices such as transmitting station 102 or receiving station 106. The software program can include machine-readable instructions that may be stored in a memory such as the memory 204 or the secondary storage 214, and that, when executed by a processor, such as the processor 202, may cause the computing device to perform the technique 1000. The technique 1000 may be implemented in whole or in part in the intra/inter prediction stage 402 of the encoder 400 of FIG. 4 and/or the intra/inter prediction stage 508 of the decoder 500 of FIG. 5. When implemented by an encoder, coding means encoding, as described with respect to FIG. 4; and when implemented by a decoder, coding means decoding, as described with respect to FIG. 5. The technique 1000 can be implemented using specialized hardware or firmware. Multiple processors, memories, or both, may be used.

At 1002, a data-driven intra-prediction mode is identified. The identification process determines which set of prediction parameters will be used for generating the prediction block. The identification can be as described above.

At 1004, features are extracted from samples neighboring a current block. This extraction involves selecting samples at predefined fixed locations from neighboring reconstructed regions and deriving features from these selected samples. The features can include a corner feature from a sample at an intersection of neighboring regions, multiple features from samples in a first neighboring region, and multiple features from samples in a second neighboring region. If any neighboring samples are unavailable, they are replaced with nearest available neighboring samples.

At 1006, the features are processed based on the data-driven intra-prediction mode to obtain processed features. This processing may include applying a set of weights to the features through matrix multiplication, where the weights are associated with the specific data-driven intra-prediction mode being used. When a transpose flag associated with the data-driven intra-prediction mode is set, spatial relationships between the features are modified before processing by swapping features derived from above the current block with features derived from left of the current block.

At 1008, the processed features are converted into a matrix. This conversion involves reshaping the processed features into a fixed-size matrix, as described herein. When the transpose flag is set, the matrix is transposed after the conversion and before resampling. At 1010, a prediction block is generated for the current block based on the matrix. This generation may include resampling the matrix to match the dimensions of the current block through dimension-by-dimension processing. The resampling may include upsampling using interpolation when a target dimension exceeds the matrix dimension, maintaining dimensions when they are equal, or downsampling using decimation when the target dimension is less than the matrix dimension.

The technique 1000 may only be performed when the dimensions of the current block are greater than or equal to a threshold size. This size-based condition ensures efficient processing of the prediction block generation.

For simplicity of explanation, the techniques 600, 900, and 1000 of FIGS. 6A, 9, and 10, respectively, are each depicted and described as respective series of steps or operations. However, the steps or operations in accordance with this disclosure can occur in various orders and/or concurrently. Additionally, other steps or operations not presented and described herein may be used. Furthermore, not all illustrated steps or operations may be required to implement a technique in accordance with the disclosed subject matter.

The aspects of encoding and decoding described above illustrate some examples of encoding and decoding techniques. However, it is to be understood that encoding and decoding, as those terms are used in the claims, could mean compression, decompression, transformation, or any other processing or change of data.

Some implementations are described below as numbered examples (Example A, B, C, etc.). These examples are provided as examples only and do not limit the other implementations disclosed herein.

Example A is a method that includes identifying a data-driven intra-prediction mode; extracting features from samples neighboring a current block; processing the features based on the data-driven intra-prediction mode to obtain processed features; converting the processed features into a matrix; and generating a prediction block for the current block based on the matrix.

Example B is the method of Example A where extracting the features from the samples neighboring the current block includes: selecting the samples at predefined fixed locations from neighboring reconstructed regions; and deriving the features from the selected samples.

Example C is the method of Example A where processing the features includes: applying a set of weights to the features, where the weights are associated with the data-driven intra-prediction mode.

Example D is the method of Example A where identifying the data-driven intra-prediction mode includes: determining that dimensions of the current block are greater than or equal to a threshold size; and selecting the data-driven intra-prediction mode from a plurality of available prediction modes based on the determining.

Example E is the method of Example A where converting the processed features into the matrix includes: reshaping the processed features into a fixed-size matrix.

Example F is the method of Example A where generating the prediction block includes: resampling the matrix to match dimensions of the current block through dimension-by-dimension processing.

Example G is the method of Example A further including: identifying a transpose flag associated with the data-driven intra-prediction mode; and when the transpose flag is set: modifying spatial relationships between the features before processing; and transposing the matrix before resampling.

Example H is the method of Example A further including: replacing an unavailable neighboring sample with a nearest available neighboring sample when extracting the features.

Example I is the method of Example A where the features include: a corner feature from a sample at an intersection of neighboring regions; a first plurality of features from samples in a first neighboring region of the current block; a second plurality of features from samples in a second neighboring region of the current block; a first overhang feature from a first overhang region extending beyond the first neighboring region; and a second overhang feature from a second overhang region extending beyond the second neighboring region.

Example J is a device that includes a memory and a processor. The processor is configured to execute instructions stored in the memory to identify a data-driven intra-prediction mode; extract features from samples neighboring a current block; process the features based on the data-driven intra-prediction mode to obtain processed features; convert the processed features into a matrix; and generate a prediction block for the current block based on the matrix.

Example K is the device of Example J where, to extract the features from the samples neighboring the current block, the processor is configured to execute instructions stored in the memory to: select the samples at predefined fixed locations from neighboring reconstructed regions; and derive the features from the selected samples.

Example L is the device of Example J where, to process the features, the processor is configured to execute instructions stored in the memory to: apply a set of weights to the features, where the weights are associated with the data-driven intra-prediction mode.

Example M is the device of Example J where the processor is further configured to execute instructions stored in the memory to: determine whether dimensions of the current block are greater than or equal to a threshold size; and perform the identifying, extracting, processing, converting, and generating in response to determining that the dimensions are greater than or equal to the threshold size.

Example N is the device of Example J where, to convert the processed features into the matrix, the processor is configured to execute instructions stored in the memory to: reshape the processed features into a fixed-size matrix.

Example O is the device of Example J where, to generate the prediction block, the processor is configured to execute instructions stored in the memory to: resample the matrix to match dimensions of the current block through dimension-by-dimension processing.

Example P is the device of Example J where the processor is further configured to execute instructions stored in the memory to: identify a transpose flag associated with the data-driven intra-prediction mode; and when the transpose flag is set: modify spatial relationships between the features before processing; and transpose the matrix before resampling.

Example Q is the device of Example J where the processor is further configured to execute instructions stored in the memory to: replace an unavailable neighboring sample with a nearest available neighboring sample when extracting the features.

Example R is the device of Example J where the features include: a corner feature from a sample at an intersection of neighboring regions; a first plurality of features from samples in a first neighboring region of the current block; a second plurality of features from samples in a second neighboring region of the current block; a first overhang feature from a first overhang region extending beyond the first neighboring region; and a second overhang feature from a second overhang region extending beyond the second neighboring region.

Example S is a non-transitory computer-readable storage medium having stored thereon an encoded bitstream, where the encoded bitstream includes: a syntax element indicating whether to use a data-driven intra-prediction mode for a current block; and a mode identifier specifying which data-driven intra-prediction mode to use; and where the encoded bitstream is decoded by operations including: extracting features from samples neighboring a current block; processing the features based on the data-driven intra-prediction mode to obtain processed features; converting the processed features into a matrix; and generating a prediction block for the current block based on the matrix.

Example T is the non-transitory computer-readable storage medium of Example S where the encoded bitstream further includes: a transpose flag associated with the data-driven intra-prediction mode; and where the operations further include: when the transpose flag is set: modifying spatial relationships between the features before processing; and transposing the matrix before generating the prediction block.

The word “example” is used herein to mean serving as an example, instance, or illustration. Any aspect or design described herein as “example” is not necessarily to be construed as being preferred or advantageous over other aspects or designs. Rather, use of the word “example” is intended to present concepts in a concrete fashion. As used in this application, the term “or” is intended to mean an inclusive “or” rather than an exclusive “or.” That is, unless specified otherwise or clearly indicated otherwise by the context, the statement “X includes A or B” is intended to mean any of the natural inclusive permutations thereof. That is, if X includes A; X includes B; or X includes both A and B, then “X includes A or B” is satisfied under any of the foregoing instances. In addition, the articles “a” and “an” as used in this application and the appended claims should generally be construed to mean “one or more,” unless specified otherwise or clearly indicated by the context to be directed to a singular form. Moreover, use of the term “an implementation” or the term “one implementation” throughout this disclosure is not intended to mean the same embodiment or implementation unless described as such.

Implementations of the transmitting station 102 and/or the receiving station 106 (and the algorithms, methods, instructions, etc., stored thereon and/or executed thereby, including by the encoder 400 and the decoder 500) can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably. Further, portions of the transmitting station 102 and the receiving station 106 do not necessarily have to be implemented in the same manner.

Further, in one aspect, for example, the transmitting station 102 or the receiving station 106 can be implemented using a general purpose computer or general purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

The transmitting station 102 and the receiving station 106 can, for example, be implemented on computers in a video conferencing system. Alternatively, the transmitting station 102 can be implemented on a server, and the receiving station 106 can be implemented on a device separate from the server, such as a handheld communications device. In this instance, the transmitting station 102, using an encoder 400, can encode content into an encoded video signal and transmit the encoded video signal to the communications device. In turn, the communications device can then decode the encoded video signal using a decoder 500. Alternatively, the communications device can decode content stored locally on the communications device, for example, content that was not transmitted by the transmitting station 102. Other suitable transmitting and receiving implementation schemes are available. For example, the receiving station 106 can be a generally stationary personal computer rather than a portable communications device, and/or a device including an encoder 400 may also include a decoder 500.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor (that is, the computer-readable medium can be a non-transitory computer-readable storage medium). The medium can be, for example, an electronic, magnetic, optical, electromagnetic, or semiconductor device. Other suitable mediums are also available.

The above-described embodiments, implementations, and aspects have been described in order to facilitate easy understanding of this disclosure and do not limit this disclosure. On the contrary, this disclosure is intended to cover various modifications and equivalent arrangements included within the scope of the appended claims, which scope is to be accorded the broadest interpretation as is permitted under the law so as to encompass all such modifications and equivalent arrangements.

What is claimed is:

1. A method, comprising:
identifying a data-driven intra-prediction mode;
extracting features from samples neighboring a current block;
processing the features based on the data-driven intra-prediction mode to obtain processed features;
converting the processed features into a matrix; and
generating a prediction block for the current block based on the matrix.

2. The method of claim 1, wherein extracting the features from the samples neighboring the current block comprises:
selecting the samples at predefined fixed locations from neighboring reconstructed regions; and
deriving the features from the selected samples.

3. The method of claim 1, wherein processing the features comprises:
applying a set of weights to the features, wherein the weights are associated with the data-driven intra-prediction mode.

4. The method of claim 1, wherein identifying the data-driven intra-prediction mode comprises:
determining that dimensions of the current block are greater than or equal to a threshold size; and
selecting the data-driven intra-prediction mode from a plurality of available prediction modes based on the determining.

5. The method of claim 1, wherein converting the processed features into the matrix comprises:
reshaping the processed features into a fixed-size matrix.

6. The method of claim 1, wherein generating the prediction block comprises:
resampling the matrix to match dimensions of the current block through dimension-by-dimension processing.

7. The method of claim 1, further comprising:
identifying a transpose flag associated with the data-driven intra-prediction mode; and
when the transpose flag is set:
modifying spatial relationships between the features before processing; and
transposing the matrix before resampling.

8. The method of claim 1, further comprising:
replacing an unavailable neighboring sample with a nearest available neighboring sample when extracting the features.

9. The method of claim 1, wherein the features comprise: a corner feature from a sample at an intersection of neighboring regions; a first plurality of features from samples in a first neighboring region of the current block; a second plurality of features from samples in a second neighboring region of the current block; a first overhang feature from a first overhang region extending beyond the first neighboring region; and a second overhang feature from a second overhang region extending beyond the second neighboring region.

10. A device, comprising:
a memory; and
a processor, the processor configured to execute instructions stored in the memory to:
identify a data-driven intra-prediction mode;
extract features from samples neighboring a current block;
process the features based on the data-driven intra-prediction mode to obtain processed features;
convert the processed features into a matrix; and
generate a prediction block for the current block based on the matrix.

11. The device of claim 10, wherein, to extract the features from the samples neighboring the current block, the processor configured to execute instructions stored in the memory to:
select the samples at predefined fixed locations from neighboring reconstructed regions; and
derive the features from the selected samples.

12. The device of claim 10, wherein, to process the features, the processor configured to execute instructions stored in the memory to:
apply a set of weights to the features, wherein the weights are associated with the data-driven intra-prediction mode.

13. The device of claim 10, the processor further configured to execute instructions stored in the memory to:
determine whether dimensions of the current block are greater than or equal to a threshold size; and
perform the identifying, extracting, processing, converting, and generating in response to determining that the dimensions are greater than or equal to the threshold size.

14. The device of claim 10, wherein, to convert the processed features into the matrix, the processor configured to execute instructions stored in the memory to:
reshape the processed features into a fixed-size matrix.

15. The device of claim 10, wherein, to generate the prediction block, the processor configured to execute instructions stored in the memory to:
resample the matrix to match dimensions of the current block through dimension-by-dimension processing.

16. The device of claim 10, the processor further configured to execute instructions stored in the memory to:
identify a transpose flag associated with the data-driven intra-prediction mode; and
when the transpose flag is set:
modify spatial relationships between the features before processing; and
transpose the matrix before resampling.

17. The device of claim 10, the processor further configured to execute instructions stored in the memory to:
replace an unavailable neighboring sample with a nearest available neighboring sample when extracting the features.

18. The device of claim 10, wherein the features comprise: a corner feature from a sample at an intersection of neighboring regions; a first plurality of features from samples in a first neighboring region of the current block; a second plurality of features from samples in a second neighboring region of the current block; a first overhang feature from a first overhang region extending beyond the first neighboring region; and a second overhang feature from a second overhang region extending beyond the second neighboring region.

19. A non-transitory computer-readable storage medium having stored thereon an encoded bitstream,
wherein the encoded bitstream comprises:
a syntax element indicating whether to use a data-driven intra-prediction mode for a current block; and
a mode identifier specifying which data-driven intra-prediction mode to use; and
wherein the encoded bitstream is decoded by operations comprising:
extracting features from samples neighboring a current block;
processing the features based on the data-driven intra-prediction mode to obtain processed features;
converting the processed features into a matrix; and
generating a prediction block for the current block based on the matrix.

20. The non-transitory computer-readable storage medium of claim 19,
wherein the encoded bitstream further comprises:
a transpose flag associated with the data-driven intra-prediction mode; and
wherein the operations further comprise:
when the transpose flag is set:
modifying spatial relationships between the features before processing; and
transposing the matrix before generating the prediction block.
